(19) United States
(12) Patent Application Publication
(10) Pub. No.: US 2014/0257777 A1
(43) Pub. Date: Sep. 11, 2014

(54) METHOD TO DETERMINE THE STABILITY OF AN APPLICATOR

(71) Applicant: THE PROCTER & GAMBLE COMPANY, Cincinnati, OH (US)

(72) Inventors: Aiqin Li, Cincinnati, OH (US); James William Busch, Maineville, OH (US)

(73) Assignee: THE PROCTER & GAMBLE COMPANY, Cincinnati, OH (US)

(21) Appl. No.: 13/785,158

(22) Filed: Mar. 5, 2013

(51) Int. Cl. G06F 17/50

(52) U.S. Cl. CPC G06F 17/5009
USPC 703/6

(57) ABSTRACT

A method of using computer based models for determining the stability of an applicator is disclosed. The method includes representing a forming cup and an applicator. The method further includes running a simulation transforming the applicator and determining the stability of the applicator.

### FIELD

In general, the present disclosure relates to computer based models for an applicator used to deliver devices or tampons into the vaginal canal. In particular, the present disclosure relates to methods of modeling the petal formation on one end of an applicator to determine the stability of the applicator.

### BACKGROUND

Designers of applicators used to deliver devices or tampons into the vaginal canal have traditionally relied upon results from physical testing of prototypes to evaluate the performance of the applicators and as a basis for making design changes. The applicators must be manufacturable while still being consumer friendly in terms of ease of use and aesthetic appeal. Developing prototypes of applicators can be expensive because the equipment necessary to manufacture the applicators may not be developed at the time when new applicators are being designed. In some instances, the materials from which the applicators will be constructed have yet to be developed. Furthermore, applicators are traditionally made from a mold, metal or otherwise. Testing multiple variables therefore requires new mold iterations for each variable study which becomes expensive and time consuming.

As a result, it would be beneficial to simulate an applicator to test for different configurations allowing one to determine the stability of the applicator.

### SUMMARY

A method of simulation, the method includes representing an applicator having a barrel and an insertion tip. The method further includes representing a forming cup. The method also includes running a simulation transforming the insertion tip of the applicator and determining the stability of the applicator.

A method of simulation, the method includes representing an applicator having a barrel and an insertion tip with two or more petals. The method further includes representing a forming cup. The method also includes running a simulation transforming the insertion tip of the applicator and determining the stability of the two or more petals.

A method of simulation, the method includes representing an applicator having a barrel and an insertion tip. The method further includes representing a forming cup. The method also includes running a simulation transforming the insertion tip of the applicator and determining the stability of the applicator. Determining the stability of the applicator includes evaluating the minimum force required for the applicator insertion tip petals to form a dome, determining the maximum force the dome can withhold before the dome collapses, determining the expulsion force of the applicator, and correlating the expulsion force of the applicator to real world parameters.

### BRIEF DESCRIPTION OF THE DRAWINGS

FIG. 1 is a chart illustrating a method for determining the stability of an applicator.

FIG. 2 is a chart illustrating a computer system.

FIG. 3 is a side elevation view of a forming cup.

FIG. 4 is a plan view of an applicator whereby the five petals are open.

FIG. 5 is an enlarged perspective view of an applicator insertion tip whereby the five petals are open.

FIG. 6 is a plan view of an applicator in contact with a forming cup.

FIG. 7 is a plan view of an applicator whereby the five petals form a dome.

FIG. 8 is an enlarged perspective view of the applicator insertion tip.

### DETAILED DESCRIPTION

As used herein, “boundary conditions” are defined variables that represent physical factors acting within a computer based model. Examples of boundary conditions include: forces, pressures, velocities, and other physical factors. Each boundary condition may be assigned a particular magnitude, direction, and location within the model. These values may be determined by observing, measuring, analyzing, and/or estimating real world physical factors. Computer based models may also include one or more boundary conditions that differ from real world physical factors, in order to account for inherent limitations in the models and/or to more accurately represent the overall physical behaviors of real world things, as will be understood by one of ordinary skill in the art. Boundary conditions may act on the model in various ways, to move, constrain, and/or deform one or more parts in the model.

As used herein, “heterogeneous” refers to a material comprised of more than one constituent or ingredient. A heterogeneous material may be a blend of materials, such as, for example, polyethylene and polypropylene.

As used herein, “initial conditions” are defined variables that represent initial factors acting within a computer based model. Examples of initial conditions include an initial configuration of the petal formation, such as, for example, an open configuration or a closed configuration.

As used herein, “stability” relates to an applicator insertion tip having one or more petals being able to hold their desired shape when subjected to outside factors, such as heat, moisture, and a movement that may occur during forming, shipping and/or during insertion into the vaginal canal. Unstable petals may open or collapse, releasing their desired shape, which may render the tampon uncomfortable to use or even unusable. Stability may be determined by quantifying multiple factors, such as, for example, by measuring the resistance to force by the insertion tip and by measuring the amount of force required to expel the tampon inside the applicator. A stable insertion tip may hold the desired shape when subjected to outside factors while exhibiting an expulsion force that falls within set parameters for the article or device.

As used herein, the term “tampon” refers to any type of absorbent structure which is inserted into the vaginal canal or other body cavities for the absorption of fluid therefrom or for the delivery of actives, such as, for example, medicaments.

The present disclosure includes methods of simulating the physical behavior of an applicator used for inserting a device or a tampon into the vaginal canal. The present disclosure assists in predicting whether or not the applicator is stable. The method of simulation includes representing an applicator with an insertion tip in an open configuration and a forming cup. The applicator is transformed by placing it in contact with the forming cup. After being transformed, the insertion tip is no longer in an open configuration. As a result, applicators may be evaluated and modified as computer based models before they are tested as real world things. The output of the simulation model may be used to run sensitivity analysis of the applicator petals regarding materials, process parameters, and different petal designs.

Computer aided engineering (CAE) is a broad area of applied science in which technologists use software to develop computer based models that represent real world things. The models may be transformed to provide information about the physical behavior of those real world things, under certain conditions and/or over particular periods of time. Within CAE, the interactions of the computer based models are referred to as simulations. Sometimes the real world things are referred to as a problem and the computer based model is referred to as a solution.

Commercially available software can be used to conduct CAE. ABAQUS™, LS DYNA™, ANSYS™, and MARC™ are examples of commercially available Structural Analysis software. The Structural Analysis software may utilize finite element analysis (FEA). In FEA, models representing mechanical articles, as well as their features, components, structures, and/or materials are transformed to predict stress, strain, displacement, deformation, and other mechanical behaviors. FEA represents a continuous solid material as a set of discrete elements. In FEA, the mechanical behavior of each element is calculated, using equations that describe mechanical behavior. The results of all of the elements are summed up to represent the mechanical behavior of the material as a whole.

Alternatively, FEA and/or CAE software can be written as custom software or may be open source code software. FEA and CAE software can be run on various computer hardware, such as, for example, a personal computer, a minicomputer, a cluster of computers, a mainframe, a supercomputer, or any other kind of machine on which program instructions can execute to perform functions.

CAE models can represent a number of real world things, such as applicators inserted into the vaginal canal to deliver tampons or other devices.

CAE can be used to design, simulate, and/or evaluate all kinds of applicators, their features, materials, structures, and compositions, as well as their performance characteristics, such as stability.

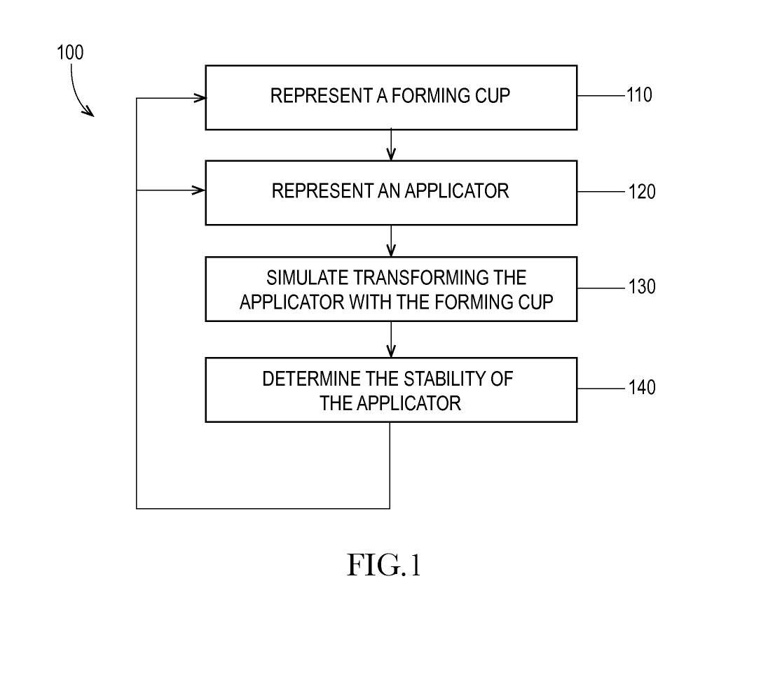

FIG. 1 is a chart illustrating a method 100 of steps 110-140 for using computer based models to determine the stability of an applicator. Although the steps 110-140 are described in numerical order in the present disclosure, in various embodiments some or all of these steps can be performed in other orders, and/or at overlapping times, and/or at the same time, as will be understood by one of ordinary skill in the art.

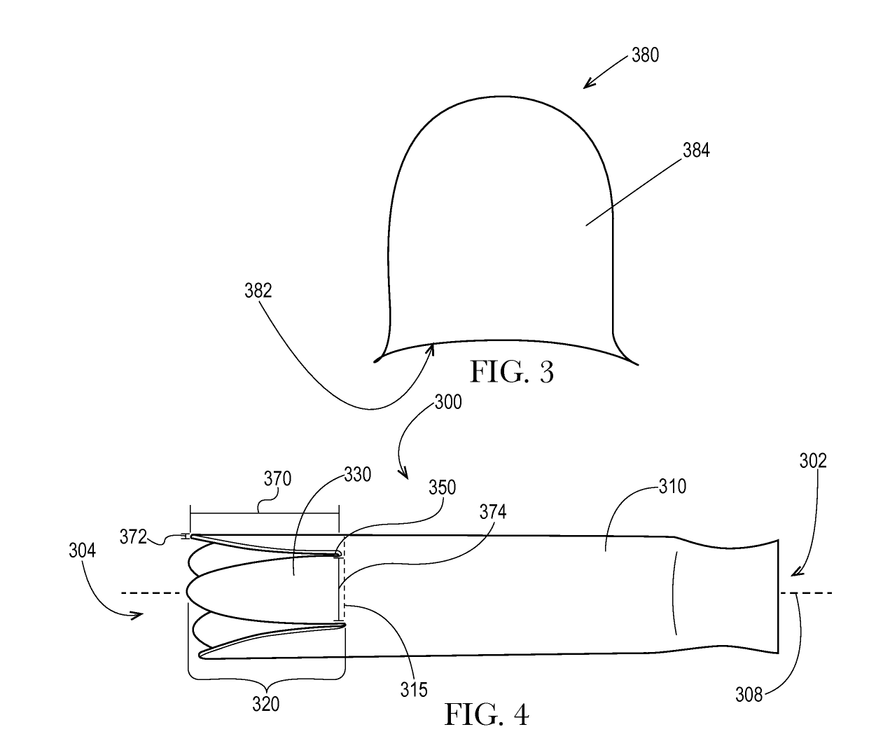

The method 100 includes a first step 110 of representing a forming cup with a computer based model. The model of the forming cup may be created as described in connection with the embodiment of FIG. 3.

Representing the forming cup may include inputting conditions for the forming cup, such as, for example, the shape of the forming cup's inner surface, the temperature of the forming cup, and the thermal conductivity of the forming cup.

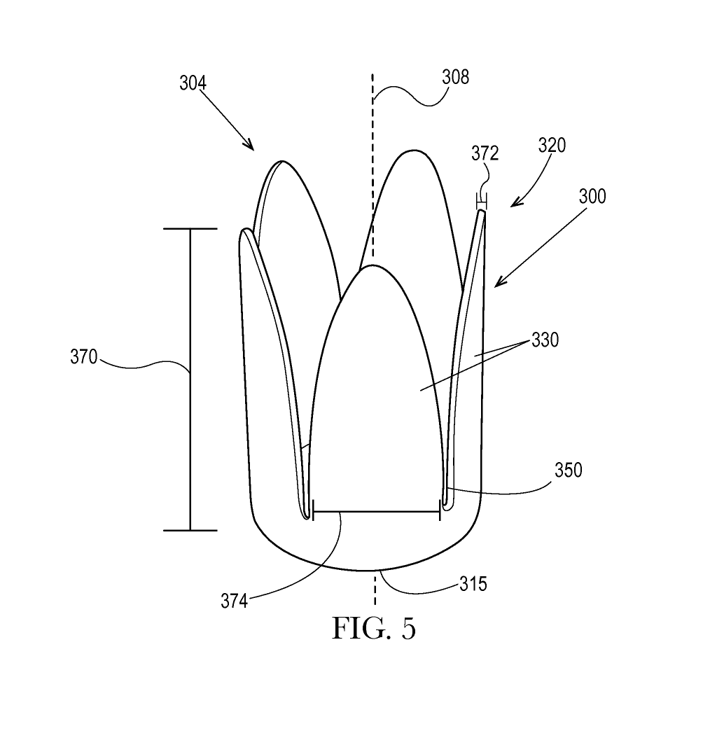

The method includes a second step 120 of representing an applicator with a computer based model. The applicator may represent a tampon applicator. The model may represent an entire applicator or may represent one or more portions of an applicator, such as, for example, an insertion tip or a petal. The model of the applicator may be created as described in connection with the embodiment of FIGS. 4 and 5. The model may represent the applicator in an open configuration or in a closed configuration.

Representing an applicator may include inputting parameters for the applicator. Parameters may be provided for the applicator as a whole or for a specific portion of the applicator. In the second step 120, the model may represent the applicator as hollow. Alternatively, in the second step 120, the model may represent the applicator as containing a tampon.

Parameters for the applicator may include any information related to the applicator, such as, for example, the material properties of the applicator as a function of temperature, the thickness of the applicator, and the thickness profile of the applicator.

Parameters for the applicator may include any information related to the petals at the insertion tip, such as, for example, the number of petals, the petal thickness, the thickness profile of individual petals, the gap between individual petals in the applicator, the size of a dome aperture formed by the petals when they are in a closed configuration, the width of the petals, the length of the petals, and the curvature of the ends of the petals along the petal perimeter.

Parameters for the applicator may include petal material properties, such as, for example, the petal elastic modulus as a function of temperature, the petal flexural modulus as a function of temperature, the petal bulk modulus as a function of temperature, an initial temperature of a petal, the initial temperature of the insertion tip, and the angle of a bent petal at the tangent of the curvature of the bend.

The method further includes a third step 130 of running a simulation transforming the applicator with the forming cup. The simulation may include the entire applicator or only the insertion tip of the applicator.

The simulation may bend the petals against the forming cup until the petals take the shape of the inner surface of the forming cup. The simulation may run until the petals collapse against the forming cup. The simulation is run based on the forming cup parameters and applicator parameters provided to the simulation. Simulation parameters may also include process conditions, such as, for example, temperature of the air in contact with the forming cup and the applicator, humidity, and the velocity at which the applicator enters the forming cup. The simulation may account for any external conditions, such as, for example, temperature and forces placed on the applicator.

The simulation software may be run to determine the petal shape of the insertion tip. The simulation software may be run for petal radius analysis of the insertion tip. The simulation may output the heat transfer between the forming cup and the insertion tip. The simulation may evaluate the contact pressure uniformity between the forming cup and the insertion tip.

The output of the model may be used to further improve the model by inputting the given first outputs as inputs to the next iteration of the model. By inserting a first set of outputs, the model may be asked to iterate a second set of results. Results for one set of parameters may be used to improve a design, the process, and the material selection. The output of the model may be inserted at any step within the model to create the next iterative set of outputs.

The method includes a fourth step 140 of determining the stability of the applicator. Determining the stability of the applicator may include determining the contact pressure distribution through the petals forming a dome, determining the expulsion force required to expel a tampon from the applicator, and/or evaluating the distribution of the contact pressure and heat transfer between the forming cup and the insertion tip of the applicator.

Determining the stability of the applicator may include determining the stability of the insertion tip. Determining the stability of the insertion tip may include determining the maximum force the insertion tip may sustain before it collapses.

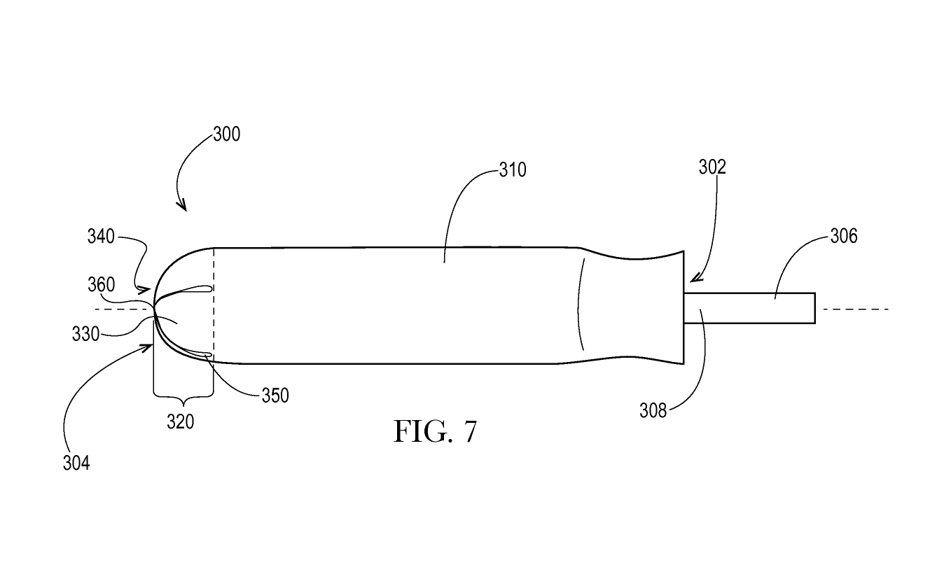

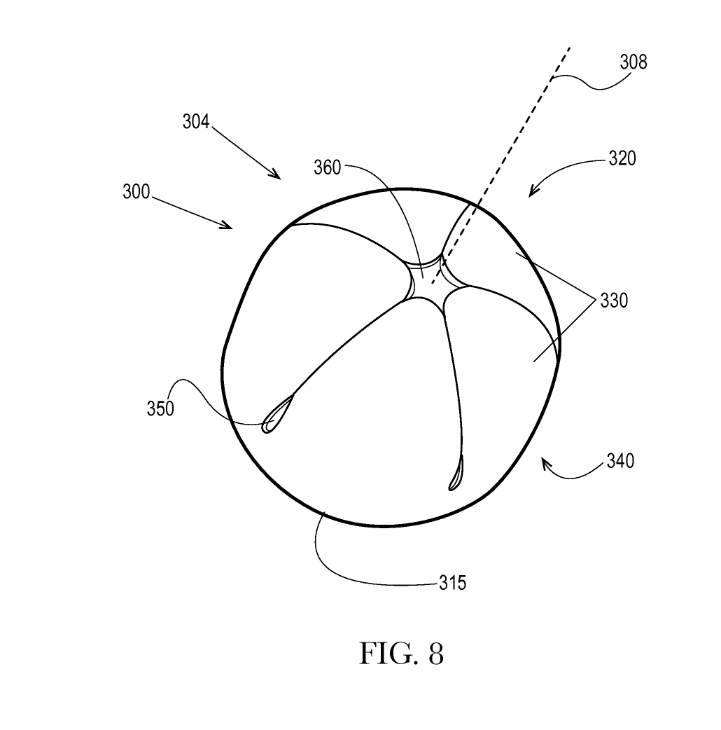

Alternatively, determining the stability of the insertion tip may be done by determining the stability of the one or more petals. Determining the stability of the one or more petals may include determining the maximum force the petals may sustain before they collapse and/or determining the minimum force needed to form a geometric shape such as a dome. While in the shape of a dome, the petals may form a dome aperture as shown in FIGS. 7 and 8. The model may determine the size of the dome aperture or, as described above, the dome aperture may be inputted as a parameter to the model.

Determining the stability of the applicator may include determining the stability of the one or more petals, such as, for example, through the petal shape analysis output. Petal shape analysis may include running thermal mechanical analysis of the petals to determine deformation and the level of force required to make full contact with the forming cup. The deformation is based on the force required to bend the petal. Petal shape analysis may be run until the petals form the dome without overlapped petals and local buckling such as dimples. The petals may also show near uniform contact pressure with the forming cup across the dome. The petal shape analysis may be used to determine the maximum force allowed within a process window determined by the minimum force required for the petals to form the dome and the maximum force the dome can withstand before the applicator or the dome buckles.

Determining the stability of the applicator may include determining the stability of the output of the petal radius analysis. Petal radius analysis may include running thermal mechanical analysis of the petals to determine deformation and the level of force required to make full contact with the forming cup. The deformation is based on the force required to bend the petal. Petal radius analysis may be run until the petals form the dome without overlapped petals and local buckling such as dimples. The petals may also show near uniform contact pressure with the forming cup across the dome. The petal radius analysis may be used to determine the maximum force allowed within a process window determined by the minimum force required for the petals to form the dome and the maximum force the dome can withstand before the applicator or the dome buckles.

The stability of the applicator may be plotted for different conditions versus real world examples to determine whether the applicator is stable. For example, the force needed to expel the tampon or device from the applicator for various applicator materials may be plotted. The force needed to expel the tampon or device may be compared to real world acceptable parameters for the tampon or device. Based on real world parameters, an acceptable expulsion force is between 50 gram force and 1000 gram force. The expulsion force may have a maximum of 600 gram force, or even less than 400 gram force, or even less than 325 gram force, or even less than 250 gram force. The expulsion force should be at least 50 gram force, or even 75 gram force. Additionally, the heat transfer between the tip of the dome and the petals may be plotted. The heat transfer from the forming cup to the petals should be such that the petals are stable in their current configuration for that given set of conditions. Determining the stability of the applicator allows for quick screening of many material properties and process parameters to determine the optimum configuration for a given set of material properties and process parameters. Depending on the stability determination of the model, the model may be run again or may be modified to adjust the parameters to the applicator and the forming cup.

The outputs of the model representing a stable applicator may be used in other models regarding an applicator, such as, for example, body fit models. Body fit models that may utilize the output of the applicator stability model include Osborn, III et al. (U.S. Patent Publication No. 2011/0172978 A1), Osborn, III et al. (U.S. Patent Publication No. 2007/0027667 A1) and Minoguchi et al. (U.S. Patent Publication No. 2007/0016391 A1).

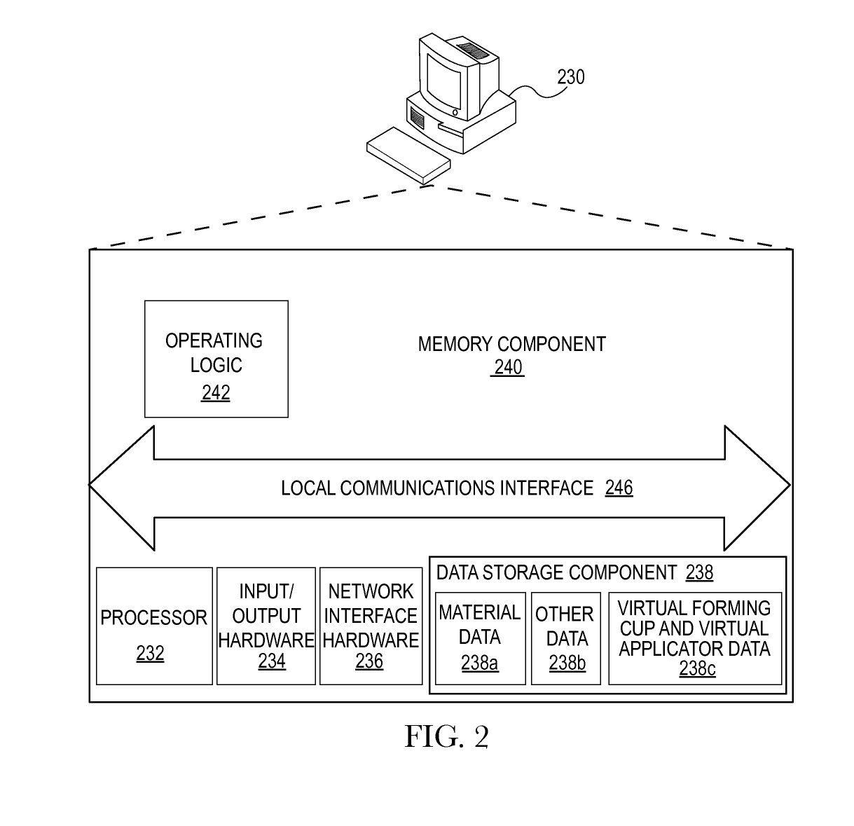

FIG. 2 depicts a computing device 230 according to systems and methods disclosed herein. The computing device 230 includes a processor 232, input/output hardware 234, network interface hardware 236, a data storage component 238 (including material data 238a, other data 238b, and forming cup and applicator data 238c), and a memory component 240. The computing device 230 may comprise a desktop computer, a laptop computer, a tablet computer, a mobile phone, or the like.

The memory component 240 of the computing device 230 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular configuration, these non-transitory computer-readable mediums may reside within the computing device 230 and/or external to the computing device 230.

The memory component 240 may be configured to store operating logic 242 that may be embodied as a computer program, firmware, and/or hardware, as an example. The operating logic 242 may include an operating system, web hosting logic, and/or other software for managing components of the computing device 230. A local communications interface 246 is also included in FIG. 2 and may be implemented as a bus or other interface to facilitate communication among the components of the computing device 230.

The processor 232 may include any processing component operable to receive and execute instructions (such as from the data storage component 238 and/or memory component 240). The input/output hardware 234 may include and/or be configured to interface with a monitor, keyboard, mouse, printer, camera, microphone, speaker, and/or other device for receiving, sending, and/or presenting data. The network interface hardware 236 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 230 and other computing devices.

Similarly, it should be understood that the data storage component 238 may reside local to and/or remote from the computing device 230 and may be configured to store one or more pieces of data for access by the computing device 230 and/or other components. In some systems and methods, the data storage component 238 may be located remotely from the computing device 230 and thus accessible via a network. Or, the data storage component 238 may merely be a peripheral device or a computer readable medium external to the computing device 230.

It should be understood that the computing device 230 components illustrated in FIG. 2 are merely exemplary and are not intended to limit the scope of this disclosure. While the components in FIG. 2 are illustrated as residing within the computing device 230, this is merely an example. In some systems and methods, one or more of the components may reside external to the computing device 230. It should also be understood that, while the computing device 230 in FIG. 2 is illustrated as a single system, this is also merely an example. In some systems and methods, the modeling functionality is implemented separately from the prediction functionality, which may be implemented with separate hardware, software, and/or firmware.

FIG. 3 is a side elevation view of a forming cup 380. The forming cup 380 has an inner surface 382 and an outer surface 384. The inside of the forming cup 380 has a set diameter and curvature. The diameter of the forming cup may be any suitable diameter, such as, for example, from about 0.05 inches to about 2 inches, from about 0.1 inches to about 1.5 inches, and from about 0.5 inches to about 1 inch.

The computer based model may be created as described below, with general references to a computer based model of a forming cup. A computer based model that represents a forming cup may be created by providing dimensions and material properties to modeling software and by generating a mesh for the forming cup using meshing software.

A computer based model of a forming cup may be created with dimensions that are similar to or the same as dimensions that represent parts of a real world forming cup. These dimensions may be determined by measuring actual samples, by using known values, or by estimating values. Alternatively, a model of a forming cup may be configured with dimensions that do not represent a real world forming cup. For example, a model of a forming cup may represent a new variation of a real world forming cup or may represent an entirely new forming cup. In these examples, dimensions for the model may be determined by varying actual or known values, by estimating values, or by generating new values. The model may be created by putting values for the dimensions of parts of the forming cup into the modeling software.

The computer based model of the forming cup may be created with material properties that are similar to or the same as material properties that represent a real world forming cup. These material properties may be determined by measuring actual samples as a function of temperature, by using known values, or by estimating values as a function of temperature. Alternatively, a model of a forming cup may be configured with material properties that do not represent a real world forming cup. For example, a model of an applicator may represent a new variation of a real world forming cup or may represent an entirely new forming cup. In these examples, material properties for the model may be determined by varying actual or known values, by estimating values, or by generating new values. The computer based model of the applicator may be created with more than one type of a forming cup.

The computer based model of the forming cup may be created with a mesh for the parts of the forming cup. A mesh is a collection of small, connected polygon shapes that define the set of discrete elements in a CAE computer based model. The type of mesh and/or the size of elements may be controlled with user inputs into the meshing software, as will be understood by one of ordinary skill in the art. An applicator may be created by using shell elements, such as, for example, linear triangular elements (also known as S3R elements) with an element size of about 1.5 millimeters. Also, a material may be created by using solid elements, such as, for example, linear hexahedral elements (also known as C3D8R elements) with an element size of about 0.25 millimeters. For clarity, the mesh is not illustrated in the embodiment of FIG. 3.

FIG. 4 is a plan view of an applicator 300. The applicator 300 has a first end 302, a second end 304, and a longitudinal axis 308 that crosses through the first end 302 and the second end 304. The first end 302 includes a barrel section 310 and the second end 304 includes an insertion tip 320 having two or more petals 330. As shown in FIG. 4, the insertion tip 320 is in an open configuration. The barrel section 310 has an end portion edge 315 connecting the barrel section 310 and the insertion tip 320. The end portion edge 315 is the line of the connecting area if the barrel section 310 and the insertion tip 320 are separate components. Alternatively, the end portion edge 315 is the imaginary line through the (imaginary) bottom of the insertion tip 320 when the insertion tip 320 is integral to the barrel section 310 as shown in FIGS. 4 and 7.

The petals 330 are in an open configuration. The two or more petals each have a length 370, a thickness 372, and a width 374.

The barrel section 310 may have any suitable inner diameter, such as, for example, 0.05 inches to 2 inches, 0.1 inches to 1.5 inches, 0.5 inches to 1 inch. The barrel section 310 may be uniform or tapered.

The barrel section 310 may have any suitable length, such as, for example, from about 0.01 inches to about 9 inches, from about 0.5 inches to about 7 inches, from about 1.0 inches to about 6 inches, from about 1.5 inches to about 5 inches, from about 2 inches to about 4 inches, such as, for example, 2.5 inches, 3 inches, 3.5 inches, 4 inches, 4.5 inches, 5.5 inches, 6.5 inches, 7.5 inches, 8 inches, or 8.5 inches.

The insertion tip 320 may have two or more petals 330, such as, for example, two to twenty petals, four to ten petals, such as, for example, five petals, six petals, seven petals, eight petals, or nine petals.

The petals 330 may be any suitable length 370, such as, for example, between 5% and 95% of the barrel section length, between 10% and 90% of the barrel section length, between 15% and 80% of the barrel section length, between 20% and 70% of the barrel section length, for example, 25%, 30%, 35%, 40%, 45%, 50%, 55%, 60%, 75%, and 85%. The length 370 may be a percentage of the entire applicator, such as, for example, between about 5% and 70% of the length of the applicator, such as, for example, 10% of the length of the applicator, 15% of the length of the applicator, 20% of the length of the applicator, 25% of the length of the applicator, 30% of the length of the applicator, 35% of the length of the applicator, 40% of the length of the applicator, 45% of the length of the applicator, 50% of the length of the applicator, 55% of the length of the applicator, 60% of the length of the applicator, or 65% of the length of the applicator. The petals 330 may have any suitable thickness 372, such as, for example, from about 0.01 inches to about 0.5 inches, from about 0.02 inches to about 0.09 inches, from about 0.05 inches to about 0.07 inches. Thin petals may exhibit lower ejection force. However, thin petals that are not stiff or rigid enough may experience tip stability problems or may collapse inward when exposed to force. The petals 330 may overlap. The petals may have uniform edge contact along the length of the petals. The petals may have a gap 350 between petals.

The width 374 of the petals 330 is a function of the barrel section 310 inner radius and the number of petals. When equal in width, the width 374 of the petals 330 is no more than the length equal to the circumference of the barrel section divided by the number of petals. Alternatively, the petals 330 may not be equal in width 374.

The applicator may be made from polymeric materials, such as, for example, polycarbonate, polyester, polyethylene, polyacrylamide, polyformaldehyde, polymethylmethacrylate, polypropylene, polytetrafluoroethylene, polytrifluorochlorethylene, polyvinylchloride, polyurethane, nylon, silicone, or mixtures or blends thereof, or metallic materials.

The computer based model may be created as described below, with general references to a computer based model of an applicator. A computer based model that represents an applicator for a tampon may be created by providing dimensions and material properties to modeling software and by generating a mesh for the applicator using meshing software.

A computer based model of an applicator may be created with dimensions that are similar to or the same as dimensions that represent parts of a real world applicator. These dimensions may be determined by measuring actual samples, by using known values, or by estimating values. Alternatively, a model of an applicator may be configured with dimensions that do not represent a real world applicator. For example, a model of an applicator may represent a new variation of a real world applicator or may represent an entirely new applicator. In these examples, dimensions for the model may be determined by varying actual or known values, by estimating values, or by generating new values. The model may be created by putting values for the dimensions of parts of the applicator into the modeling software.

The computer based model of the applicator may be created with material properties that are similar to or the same as material properties that represent a real world applicator. These material properties may be determined by measuring actual samples as a function of temperature, by using known values, or by estimating values as a function of temperature. Alternatively, a model of an applicator may be configured with material properties that do not represent a real world applicator. For example, a model of an applicator may represent a new variation of a real world applicator or may represent an entirely new applicator. In these examples, material properties for the model may be determined by varying actual or known values, by estimating values, or by generating new values. The computer based model of the applicator may be created with more than one type of an absorbent material.

The computer based model of the applicator may be created with a mesh for the parts of the applicator. A mesh is a collection of small, connected polygon shapes that define the set of discrete elements in a CAE computer based model. The type of mesh and/or the size of elements may be controlled with user inputs into the meshing software, as will be understood by one of ordinary skill in the art. An applicator may be created by using shell elements, such as linear triangular elements (also known as S3R elements) with an element size of about 1.5 millimeters.

Also, a material may be created by using solid elements, such as linear hexahedral elements (also known as C3D8R elements) with an element size of about 0.25 millimeters. For clarity, the mesh is not illustrated in the embodiment of FIG. 4.

FIG. 5 is an enlarged perspective view of the applicator 300 insertion tip 320 taken from the end portion edge 315 to the second end 304 of the applicator 300. The insertion tip 320 has five petals 330. The longitudinal axis 308 crosses through the second end 304 of the applicator 300. The petals 330 shown in FIG. 5 are in an open configuration and have a length 370, a thickness 372, and a width 374. The insertion tip 320 has a gap 350 between the petals 330. The open configuration may be used prior to contacting the insertion tip with the forming cup.

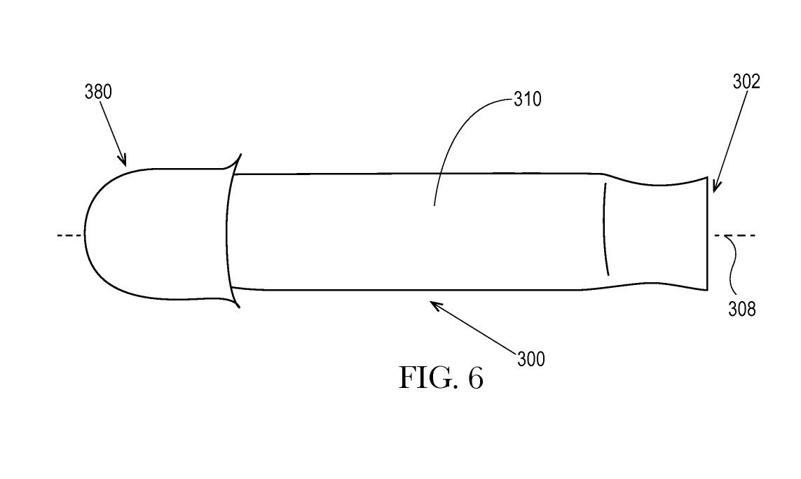

FIG. 6 is a plan view of the applicator 300 of FIGS. 4 and 5 in contact with the forming cup 380 of FIG. 3. The applicator first end 302 and barrel section 310 are not in contact with the forming cup 380. The longitudinal axis 308 crosses through the first end 302 and the forming cup 380.

FIG. 7 is a plan view of the applicator 300 with the first end 302, the second end 304, and the longitudinal axis 308 that crosses through the first end 302 and the second end 304. The first end 302 includes the barrel section 310 and the second end 304 includes the insertion tip 320 including two or more petals 330. The end portion edge 315 connects the insertion tip 320 and the barrel section 310. As shown in FIG. 7, the petals 330 may form a dome 340. The petals 330 may have a gap 350 between the petals 330. The dome 340 may have a dome aperture 360. Alternatively, the petals 330 may form any geometric shape that may be formed by a forming cup 380, such as, for example, an arch, a vault, or a pyramid.

As shown in FIG. 7, the applicator 300 may also have a plunger 306 or a telescoping second tube, which can be pushed inside the barrel section 310 to engage with a tampon or a device, which may be inside the applicator 300 and not visible, to push the tampon or device out of the barrel section 310 and through the insertion tip 320.

FIG. 8 is an enlarged perspective view of the second end 304 of the applicator 300 having the insertion tip 320 with the longitudinal axis 308 crossing through the second end 304. The insertion tip 320 has a dome 340 that extends from the end portion edge 315. The dome 340 is formed by five petals 330. The petals have a gap 350 between the petals. As shown in FIG. 8, the petals may form the dome aperture 360.

The expulsion force criteria of the applicator stability may be modeled according to the following relationship. The expulsion force increases as a function of increased thickness, increased petal width, and decreased petal length. This model is based on the beam equation providing a qualitative assessment of petal bending strength. Petal bending strength relates to both the transforming of the insertion tip and the expulsion force. The petal is considered a cantilevered beam that is bent then forced open when the tampon is expelled. The force to bend one petal is quantified by:

P=2EI_{yc}θ/L²

where P equals the bending force, E equals the modulus of Elasticity, I equals the area moment of inertia of the petal cross section, θ equals the angle of bent petal at the tangent of curvature of the bend, and L equals petal length.

This equation shows that the square of the petal length is inversely proportional to the force, meaning that increased petal length will cause a significant decrease in expulsion force with all other properties held constant. The impact of petal width and thickness are contained within the formula for the moment of inertia (I) and have a direct relationship with the force.

The moment of inertia, I, of the petal cross section can be calculated as:

$${I}_{yc} = \frac{1}{8} ( {r}_{0}^{4} - {r}_{i}^{4} ) ( 2 φ + sin 2 φ ) - {Ax}_{c}^{2} \approx {r}_{i}^{3} t ( φ + \frac{1}{2} sin 2 φ - \frac{2 {sin}^{2} φ}{φ} ) .$$

where the Y axis represents the longitudinal axis of the applicator along the central point of the inner cross sectional area of the applicator, r₀ represents the outer radius taken from the Y axis, rᵢ represents the inner radius or barrel section radius taken from the Y axis, φ represents the angle formed by the arc along the petal starting at the cross section of the Y axis at the center of the petal height to the tip of the petal, and t represents the thickness of the petal.
The Area can be calculated as:

A=φ(r₀²−rᵢ²)≈2φrᵢt

The center of mass can be calculated as:

$${x}_{c} = \frac{2 sin φ}{3 φ} \frac{{r}_{0}^{2} + {r}_{i} {r}_{0} + {r}_{i}^{2}}{{r}_{i} + {r}_{o}} \approx \frac{{r}_{i} sin φ}{φ}$$

The thickness can be calculated as:

t=rₒ−rᵢ

Therefore, I_{yc} is directly proportional to the cube of the barrel section radius, petal thickness, and the petal interior angle (φ) which is inversely proportional to the number of petals.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “0.5 in.” is intended to mean “about 0.5 in.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of simulation, comprising:
representing a forming cup;
representing an applicator comprising a barrel section and an insertion tip;
running a simulation transforming the insertion tip of the applicator with the forming cup; and
determining the stability of the applicator.

2. The method of claim 1, wherein the insertion tip comprises two or more petals.

3. The method according to claim 2, wherein representing an applicator comprises inputting one or more parameters selected from the group consisting of the number of petals, the thickness of the petals, the thickness profile of individual petals, a gap between individual petals, the size of a dome aperture formed by the petals, the width of the petals, the length of the petals, the curvature of the ends of the petals along the petal perimeter, and/or combinations thereof.

4. The method according to claim 2, wherein representing an applicator comprises inputting one or more parameters selected from the group consisting of the petal modulus of elasticity as a function of temperature, the petal flexural modulus as a function of temperature, the petal bulk modulus as a function of temperature, the initial temperature of a petal, the initial temperature of the insertion tip, the angle of a bent petal at the tangent of the curvature of the bend, and/or combinations thereof.

5. The method of claim 3, wherein the length of the petals is between 5% and 70% of the applicator.

6. The method of claim 1, wherein determining the stability of the applicator comprises evaluating the minimum force required for the insertion tip to form a dome.

7. The method of claim 6, wherein the method further comprises determining the size of a dome aperture when the petals form the dome.

8. The method of claim 1, wherein the method further comprises determining the heat transfer between the forming cup and the insertion tip.

9. The method of claim 1, wherein the method further comprises evaluating the contact pressure uniformity between the forming cup and the insertion tip.

10. The method of claim 1, wherein determining the stability of the applicator comprises determining the maximum force the insertion tip can withhold before collapsing.

11. The method of claim 1, wherein determining the stability of the applicator comprises determining the expulsion force of the applicator.

12. A method of simulation, comprising:
representing a forming cup;
representing an applicator comprising an insertion tip with two or more petals;
running a simulation transforming the applicator; and
determining the stability of the two or more petals.

13. The method of claim 12, wherein representing an applicator comprises inputting one or more parameters selected from the group consisting of the number of petals, the thickness of the petals, the thickness profile of individual petals, a gap between individual petals, the size of a dome aperture formed by the petals, the width of the petals, the length of the petals, the curvature of the ends of the petals along the petal perimeter, and/or combinations thereof.

14. The method of claim 12, wherein representing an applicator comprises inputting one or more parameters selected from the group consisting of the petal modulus of elasticity as a function of temperature, the petal flexural modulus as a function of temperature, the petal bulk modulus as a function of temperature, the initial temperature of a petal, the initial temperature of the insertion tip, the angle of a bent petal at the tangent of the curvature of the bend, and/or combinations thereof.

15. The method of claim 12, wherein the applicator is a tampon applicator.

16. The method of claim 12, wherein determining the stability of the two or more petals comprises evaluating the minimum force required for the applicator insertion tip petals to form a dome.

17. The method of claim 16, wherein determining the stability of the two or more petals comprises determining the maximum force the dome can withhold before the dome collapses.

18. The method of claim 16, wherein the method further comprises determining the size of a dome aperture when the petals form the dome.

19. The method of claim 12, wherein determining the stability of the two or more petals comprises determining the expulsion force of the applicator.

20. A method of simulation, comprising:
representing a forming cup;
representing an applicator comprising an insertion tip with two or more petals;
running a simulation transforming the applicator; and
determining the stability of the applicator;
wherein determining the stability of the applicator comprises evaluating the minimum force required for the applicator insertion tip petals to form a dome, determining the maximum force the dome can withhold before the dome collapses, determining the expulsion force of the applicator, and correlating the expulsion force of the applicator to real world parameters.
